(19) United States
(12) Patent Application Publication
(10) Pub. No.: US 2007/0111099 A1
(43) Pub. Date: May 17, 2007

(54) Primary lithium ion electrochemical cells

(76) Inventors: Kirakodu S. Nanjundaswamy, Sharon, MA (US); Fan Zhang, Needham, MA (US); Dean Delehanty MacNeil, Toronto (CA); David Leigh DeMuth, Maynard, MA (US); Ou Mao, Walpole, MA (US); Todd E. Bofinger, Nashua, NH (US); William L. Bowden, Nashua, NH (US)

Correspondence Address: FISH & RICHARDSON P.C., P.O. BOX 1022, MINNEAPOLIS, MN, 55440-1022, US

(21) Appl. No.: 11/274,980

(22) Filed: Nov. 15, 2005

(51) Int. Cl. H01M 4/58; H01M 4/50; H01M 4/52; H01M 4/40; H01M 6/00

(52) U.S. Cl. 429/231.95; 429/223; 429/224; 429/231.1; 429/231.3; 29/623.1; 429/50

(57) ABSTRACT

A primary battery includes a positive electrode having a first material capable of bonding with lithium, a negative electrode having lithium, and a non-aqueous electrolyte. The primary battery is capable of providing an average load voltage of greater than about 3.5 volts.

### TECHNICAL FIELD

The invention relates to primary lithium ion electrochemical cells.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

### SUMMARY

The invention relates to primary lithium ion electrochemical cells. The primary lithium ion cells are capable of having discharge characteristics comparable to certain secondary lithium ion electrochemical cells (e.g., high drain rates, large energy density, and/or constant capacity), and long calendar life (e.g., they can retain their charges over extended periods of time). The primary lithium ion cells may be received in a charged (e.g., fully charged) condition by a user (e.g., a consumer), so the cells may be used immediately without charging by the user. As a result, the cells can serve as a direct, drop-in, back-up power source for certain rechargeable electrochemical cells, such as rechargeable lithium cells supplied with digital cameras, camcorders, and laptop computers. Since the primary lithium ion cells are capable of having voltage characteristics that are compatible with certain rechargeable cells (such as 4V lithium cells), in some embodiments, there is no need to use a voltage converter, which can sometimes decrease the efficiency of a cell. Additionally, the primary lithium ion cells can be cost efficient to produce, for example, by having a few number of charging cycle(s) and/or by having a negative electrode substantially free of lithium. A cell with lowered lithium amounts may also be safer to use and less affected by certain regulations.

In one aspect, the invention features a primary (i.e., adapted to be non-rechargeable) battery including a positive electrode comprising a first material capable of bonding with lithium; a negative electrode comprising lithium; and a non-aqueous electrolyte, wherein the battery is capable of providing an average load voltage of greater than about 3.5 volts.

Embodiments may include one or more of the following features. The first material comprises a mixed metal oxide. The first material is selected from the group consisting of Li(Ni,Co,Mn)O₂ and Li(Mn,Ni)O₂. The first material has less than about three percent by weight of lithium prior to an initial discharge of the battery. The positive electrode is in a fully charged state prior to an initial discharge of the battery. The negative electrode comprises a solid solution comprising lithium. The negative electrode comprises an alloy comprising lithium. The negative electrode comprises a substrate and a first layer on the substrate, the first layer capable of combining with lithium. The substrate comprises copper, and the first layer comprises an alloy comprising copper. The alloy further comprises tin.

In another aspect, the invention features a method of making a primary battery, the method comprising assembling a positive electrode comprising a first material capable of bonding with lithium, a negative electrode, and a non-aqueous electrolyte into a battery housing; and fully charging the battery, wherein the battery is capable of providing an average load voltage of greater than about 3.5 volts.

Embodiments may include one or more of the following features. The first material comprises a mixed metal oxide. The first material is selected from the group consisting of Li(Ni,Co,Mn)O₂ and Li(Mn,Ni)O₂. The first material has less than about three percent by weight of lithium after the battery is fully charged. Charging the battery comprises forming a solid solution comprising lithium in the battery housing. Charging the battery comprises forming an alloy comprising lithium in the battery housing. The negative electrode comprises an alloy. The alloy comprises at least one element selected from the group consisting of copper and tin. The negative electrode comprises a substrate, and a first layer on the substrate, the first layer having a different composition than a composition of the substrate. The negative electrode is substantially free of lithium prior to an initial charging. Charging the battery increases a lithium content of the negative electrode. The negative electrode comprises lithium prior to an initial charging.

In another aspect, the invention features a method comprising discharging, without previously charging, a battery comprising a positive electrode comprising a first material capable of bonding with lithium, a negative electrode comprising lithium, and a non-aqueous electrolyte, the battery capable of providing an average load voltage of greater than about 3.5 volts; and after discharging the battery, discarding the battery the battery without charging the battery.

Embodiments may include one or more of the following features. The first material comprises a mixed metal oxide. The first material is selected from the group consisting of Li(Ni,Co,Mn)O₂ and Li(Mn,Ni)O₂. The first material has less than about three percent by weight of lithium prior to discharging the battery. The positive electrode is in a fully charged state prior to discharging the battery. The negative electrode comprises a solid solution comprising lithium. The negative electrode comprises an alloy comprising lithium. The negative electrode comprises a substrate and a first layer on the substrate, the first layer capable of combining with lithium. The substrate comprises copper, and the first layer comprises an alloy comprising copper. The alloy further comprises tin.

Other aspects, features, and advantages are in the description, drawings, and claims.

### DESCRIPTION OF DRAWINGS

FIG. 1 is an exploded view of an embodiment of an electrochemical cell.

FIG. 2 is a plot of cell potential vs. cell capacity for a fresh cell having a LiCo_{1/3}Mn_{1/3}Ni/_{1/3} cathode and a lithium/aluminum anode.

FIG. 3 is a plot of cell potential vs. cell capacity for a stored cell (20 days at 60C) having a LiCo_{1/3}Mn_{1/3}Ni_{1/3} cathode and a lithium/aluminum anode.

FIG. 4 are plots of cell potential vs. cell capacity for a fresh cell and a stored cell (20 days at 60C) having a LiCo_{1/3}Mn_{1/3}Ni_{1/3} cathode and a copper foil anode.

FIG. 5 is a plot of cell potential vs. cell capacity for a fresh cell having a LiCo_{1/3}Mn_{1/3}Ni_{1/3} cathode and a hot-tin-dipped copper foil anode.

FIG. 6 are plots of cell potential vs. cell capacity for a fresh cell and a stored cell (20 days at 60C) having a LiCo_{1/3}Mn_{1/3}Ni_{1/3} cathode and a lithium-deposited copper foil anode.

FIG. 7 are plots of cell potential vs. cell capacity for a fresh cell and a stored cell (20 days at 60C) having a LiCo_{1/3}Mn_{1/3}Ni_{1/3} cathode and a zinc-plated copper foil anode.

### DETAILED DESCRIPTION

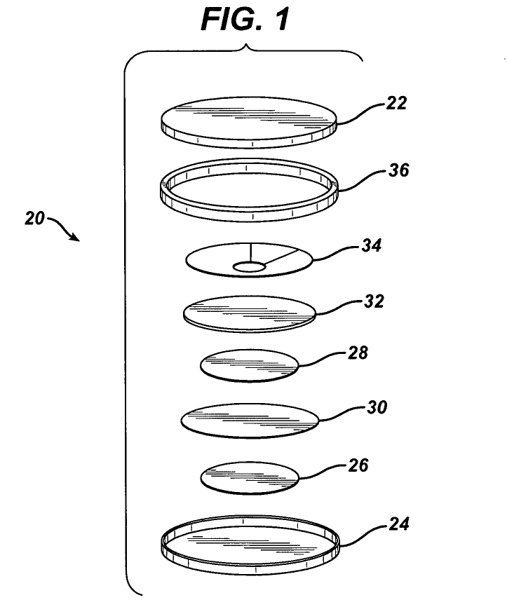

Referring to FIG. 1, a nominally 4V primary lithium ion electrochemical cell 20 is shown. Cell 20 includes an upper cell housing 22, a lower cell housing 24, a positive electrode 26 in the lower cell housing, a negative electrode 28 in the upper cell housing, and a separator 30 positioned between the positive and negative electrodes. Cell 20 also includes a conductive spacer 32, a spring 34, and a gasket 36. Upper cell housing 22 serves as the negative terminal for cell 20, and lower cell housing 24 serves as the positive terminal for the cell. An electrolyte solution is distributed throughout cell 20.

As indicated above, cell 20 is a primary cell. Primary electrochemical cells are meant to be discharged completely, e.g., to exhaustion, only once, and then discarded. Primary cells are not intended to be recharged. Primary cells are described, for example, in David Linden, Handbook of Batteries (McGraw-Hill, 2d ed. 1995). Secondary electrochemical cells can be recharged for many times, e.g., more than fifty times, more than a hundred times, or more than five hundred times. In some cases, secondary cells can include relatively robust separators, such as those having multiple layers and/or that are relatively thick. Secondary cells can also be designed to accommodate changes, such as swelling of the electrodes, that can occur during cycling. Secondary cells are described, for example, in D. Linden and T. B. Reddy, ed., Handbook of Batteries (McGraw-Hill, 3^{rd} ed. 2001); J. P. Gabano, ed., Lithium Batteries (Academic Press, 1983); G. A. Nazri and G. Pistoia, ed., Lithium Batteries (Kluwer Academic, 2004).

Cell 20 is capable of providing high voltage characteristics and long calendar life. For example, cell 20 is capable of providing an average load voltage of greater than about 3.5 volts (e.g., about 3.7 volts) with a cutoff voltage of about 2.8 volts. The running voltage can range from about 2.8 to a maximum of about 4.6 volts. At the same time, cell 20 is capable of providing good calendar life, in some embodiments, losing less than 25% of its capacity over three weeks of storage at 60 degrees C. Thus, cell 20 is capable of providing the voltage characteristics comparable to certain secondary lithium ion cells while having an extended calendar life.

Positive electrode 26 includes a mixture having an electroactive material, an electrically conductive additive to improve the bulk electrical conductivity of the positive electrode, and optionally, a binder to improve physical integrity of the positive electrode. The mixture may be supported on one or more surfaces of a conductive substrate, such as an aluminum or stainless steel grid or foil.

The electroactive material in positive electrode 26 includes a material capable of reversibly releasing lithium and bonding with lithium. The electroactive material can bond with lithium on the surface of the electroactive material, and/or the electroactive material can bond with lithium in the bulk of the electroactive material, for example, by allowing the lithium to enter into (e.g., intercalate) the structural lattice of the electroactive material. In some embodiments, the electroactive material has good thermal stability, produces low gassing, retains its charge well (e.g., does not lose a substantial amount of capacity during storage), and/or has a high rate capability (e.g., due to a low polarization from a fast lithium ion insertion reaction). Examples of electroactive materials include mixed metal oxides that are capable of providing high capacities and high voltages, such as Li_{q}(Mnₓ,Ni_{y})O₂, where x+y=1, and 1≦q≦1.15; and Li_{q}(NiₐCo_{b}Mn_{c})O₂, where a+b+c=1 (e.g., a=b=c=1/3), and 1≦q≦1.15. Li(Mnₓ,Ni_{y})O₂ and Li(NiₐCo_{b}Mn_{c})O₂ are available, for example, from Nichia (Japan), Tanaka (Japan), Kerr-McGee, and 3M (Minnesota, USA). Specific examples of electroactive materials include Li(Ni_{1/3}Co_{1/3}Mn_{1/3})O₂; Li(Ni_{0.42}Co_{0.16}Mn_{0.42})O₂; Li(Ni_{0.10}Co_{0.80}Mn_{0.10})O₂; Li(Ni_{0.20}Co_{0.60}Mn_{0.20})O₂; Li(Ni_{0.65}Co_{0.25}Mn_{0.10})O₂; Li_{1.06}Mn_{0.53}Ni_{0.42}O₂; Li_{1.11}Mn_{0.56}Ni_{0.43}O₂; and LiMn_{0.5}Ni_{0.5}O₂. In some embodiments, positive electrode 26 includes a coating consisting from about 84 percent to about 92 percent by weight of the electroactive material, for example, from about 87 percent to about 92 percent by weight, or from about 90 percent to about 92 percent by weight, of the electroactive material. Positive electrode 26 can include greater than or equal to about 84 percent, about 84 percent, about 85 percent, about 86 percent, about 87 percent, about 88 percent, about 89 percent, about 90 percent, or about 91 percent by weight, and/or less than or equal to about 92 percent, about 91 percent, about 90 percent, about 89 percent, about 88 percent, about 87 percent, about 86 percent, about 85 percent, about 84 percent, or about 83 percent by weight of the electroactive material. Positive electrode 26 can include one or more (e.g., two, three or more) different compositions of electroactive material, in any combination. For example, positive electrode 26 can include a mixture of Li(Mnₓ,Ni_{y})O₂ and Li(NiₐCo_{b}Mn_{c})O₂.

In addition, as indicated above, positive electrode 26 can include one or more electrically conductive additives capable of enhancing the bulk electrical conductivity of the positive electrode. Examples of conductive additives include natural or non-synthetic graphite, oxidation-resistant natural or synthetic graphite (e.g., Timrex® SFG-6, available from Timcal America, Inc.), synthetic graphite (e.g., Timrex® KS-6, available from Timcal America, Inc.), oxidation-resistant carbon blacks, including highly graphitized carbon blacks (e.g., MM131, MM179 available from Timcal Belgium N.V.), Shawinigan acetylene black (SAB), gold powder, silver oxide, fluorine-doped tin oxide, antimony-doped tin oxide, zinc antimonate, indium tin oxide, cobalt oxides, (e.g., cobalt oxyhydroxide, and/or carbon nanofibers. In certain embodiments, the graphite particles are nonsynthetic, nonexpanded graphite particles (e.g., MP-0702X available from Nacional de Grafite, Itapecirica MG, Brazil). In other embodiments, the graphite particles are synthetic, non-expanded graphite particles, (e.g., Timrex® KS6, KS10, KS15, KS25 available from Timcal, Ltd., Bodio, Switzerland). The conductive additive particles can be oxidation-resistant, synthetic or natural, graphite or highly graphitized carbon black particles.

Mixtures of conductive additives can be used, such as a mixture of graphite particles (e.g., including from about 10 to about 100 weight percent of oxidation-resistant graphite) and carbon nanofibers. Oxidation-resistant synthetic or natural graphites are available from, for example, Timcal, Ltd., Bodio, Switzerland (e.g., Timrex® SFG6, SFG10, SFG15, SFG44, SLP30) or Superior Graphite Co., Chicago, Ill. (e.g., 2939 APH-M). Carbon nanofibers are described, for example, in commonly-assigned U.S. Ser. No. 09/829,709, filed Apr. 10, 2001 and U.S. Pat. No. 6,858,349. Positive electrode 26 can include from about 5 to about 10 percent by weight of conductive additive. For example, positive electrode 26 can include greater than or equal to about 5, about 6, about 7, about 8, or about 9 percent by weight of the conductive additive; and/or less than or equal to about 10, about 9, about 8, about 7, or about 6 by weight of the conductive additive.

A binder (e.g., a polymer or co-polymer) can be added to enhance the structural integrity of positive electrode 26. Examples of binders include polyethylene, polyacrylamides, styrenic block co-polymers (e.g., Kraton™ G), Viton®, and various fluorocarbon resins, including polyvinylidene fluoride (PVDF) (such as 10% solution of PVDF dissolved in 1-methyl-2-pyrrolidinone (NMP, which is a solvent used for coating lithium ion anodes and cathodes because it can dissolve binder (e.g., Kynar) and can be relatively easily removed by drying)), polyvinylidene fluoride co-hexafluoropropylene (PVDF-HFP), and polytetrafluoroethylene (PTFE). An example of a polyvinylidene fluoride binder is sold under the tradename Kynar® 741 resin (available from Atofina Chemicals, Inc.). An example of a polyvinylidene fluoride co-hexafluoropropylene binder is sold under the tradename Kynar Flex® 2801 resin (available from Atofina Chemicals, Inc.). An example of a polytetrafluoroethylene binder is sold under the tradename T-60 (available from Dupont). Positive electrode 26 can include, for example, from about 2 percent to about 6 percent by weight of binder (such as greater than or equal to about 2, about 3, about 4, or about 5 percent by weight of binder; and/or less than or equal to about 6 percent, about 5 percent, about 4, or about 3 percent by weight of binder).

Similar to positive electrode 26, negative electrode 28 includes an electroactive material capable of bonding with lithium and releasing lithium. The electroactive material of negative electrode 28 can bond with lithium on the surface of the electroactive material, and/or the electroactive material can bond with lithium in the bulk of the electroactive material, for example, by allowing the lithium to enter into the structural lattice of the electroactive material. As described further below, prior to use, cell 20 is charged (e.g., during cell assembly), and during use, the cell is discharged (e.g., in an electronic device). In some embodiments, when cell 20 is charged, lithium is removed from the electroactive material of positive electrode 26 and transferred to negative electrode 28, where the lithium bonds with the negative electrode. When cell 20 is subsequently discharged (e.g., by a consumer), lithium is removed from negative electrode 28 and transferred to positive electrode 26, where the lithium bonds with the electroactive material of the positive electrode.

A number of embodiments of negative electrode 28 can be used to construct cell 20. For example, negative electrode 28 may include one or more materials capable of alloying with lithium to form one or more discrete phases, and/or capable of reacting with lithium to form one or more intermetallic solid solutions with a wide range of chemical compositions. These materials preferably bond well with lithium, and reversibly and efficiently release lithium upon discharge of cell 20. Examples of materials include copper, magnesium, silver, aluminum, zinc, bismuth, antimony, indium, silicon, lead, or tin. Thus, in some embodiments, negative electrode 28 is substantially free of lithium after cell 20 is assembled and before an initial charging. In some embodiments, the material(s) capable of alloying with lithium and/or capable of reacting with lithium to form an intermetallic solid solution can be formed on a substrate as one or more layers (such as a tie layer). For example, one or more layers of zinc can be formed on a substrate (e.g., copper), or tin can be formed on a copper substrate to form a copper alloy capable of bonding and releasing lithium, such as brass, bronze, CuZn, Cu₆Sn₅ and Cu₃Sn, for example, by dipping a copper substrate in molten tin. The substrate can provide negative electrode 28 with good conductivity and good mechanical properties, such as malleability and ductility. After the layer(s) is formed on the substrate, the layer(s) and the substrate can be annealed (e.g., at 250 C for one hour) or unannealed. The thickness of the layer(s) can range from about 0.1 micrometer to about 10 micrometers. For example, the thickness of the layer(s) can be greater than or equal to about 0.1 micrometer, about 1 micrometer, about 3 micrometers, about 5 micrometers, about 7 micrometers, or about 9 micrometers; and/or less than or equal to about 10 micrometers, about 8 micrometers, about 6 micrometers, about 4 micrometers, or about 2 micrometers. In some embodiments, the layer(s) can include one or more layers having materials that electrochemically alloy readily at ambient temperatures, such as zinc, bismuth, antimony, indium, silicon, lead, and aluminum. Other examples for negative electrode 28 include amorphous metal foils such as Fe—Si—B, Cu—Al—Mg; lead-free solder materials, such as Sn—Ag—Cu; magnesium-lithium alloys (e.g., a solid solution of 80% lithium and 20% magnesium by weight prepared by arc-furnace melting and subsequently cold-rolling to about 30 to about 100 microns thick); and lithium-coated substrates, such as a copper substrate (e.g., a foil) having vapor deposited or sputtered lithium (e.g., from about 1 micron to about 25 microns thick, such as from about 10 to about 20 microns thick).

Separator 30 can be formed from any of the separator materials typically used in lithium primary or secondary cells. Separator 30 can include one or more layers of different separator materials, in any combination. For example, separator 30 can be a thin, porous membrane or film. Separator 30 can have a thickness between about 10 microns and 200 microns, between about 20 microns and 50 microns. The size of the pores in the porous membrane can range from 0.03 microns to 0.2 microns, for example. The porous membrane can include relatively non-reactive polymers such as microporous polypropylene (e.g., Celgard® 2300, Celgard® 3559, Celgard® 5550, Celgard® 5559 or Celgard® 2500, Celgard® CG2300 (a trilayer separator consisting of two layers of polypropylene that sandwich a layer of polyethylene), or Celgard® 2400), polyethylene, polyamide (i.e., a nylon), polysulfone or polyvinyl chloride. Separator 30 can include a thin non-woven sheet. Separator 30 can include a ceramic or an inorganic membrane.

The electrolyte solution can include one or more non-aqueous solvents and at least one electrolyte salt soluble in the electrolyte solvent. In some embodiments, the electrolyte solution is resistant to possible oxidation by the high voltage of cell 20, and does not adversely react with (e.g., degrade) the other components of the cell. The electrolyte salt can be a lithium salt selected from LiClO₄, LiPF₆, LiBF₄, LiAsF₆, LiCF₃SO₃, LiAlCl₄, LiN(CF₃SO₂)₂, Li(C₄F₉SO₂NCN), LiB(C₂O₄)₂, and LiB(C₆H₄O₂)₂. The concentration of the electrolyte salt in the electrolyte solution can range from about 0.01 M to about 3 M, for example, from about 0.5 to 1.5 M. The electrolyte solvent can be an aprotic organic solvent. Examples of aprotic organic solvents include cyclic carbonates, linear chain carbonates, ethers, cyclic ethers, esters, alkoxyalkanes, nitriles, organic phosphates, and tetrahydrothiophene 1,1-dioxide (i.e., sulfolane). Examples of cyclic carbonates include ethylene carbonate, propylene carbonate, and butylene carbonate. Examples of linear chain carbonates include dimethyl carbonate, diethyl carbonate, ethyl methyl carbonate, and the like. Examples of ethers include diethyl ether and dimethyl ether. Examples of alkoxyalkanes include dimethoxyethane, diethoxyethane, and methoxyethoxyethane. Examples of cyclic ethers include tetrahydrofuran and dioxolane. Examples of esters include methyl acetate, methyl propionate, ethyl propionate, methyl butyrate, and gamma-butyrolactone. An example of a nitrile includes acetonitrile. Examples of organic phosphates include triethylphosphate and trimetylphosphate. The electrolyte can be a polymeric electrolyte. The polymeric electrolyte also can include a solvent. An example of an electrolyte is a solution containing 1 M LiPF₆ dissolved in a mixture of ethylene carbonate and diethyl carbonate in a 1:1 ratio by volume. The electrolyte optionally can include an additive such as vinyl ethylene carbonate, vinylene carbonate, and derivatives thereof. Other electrolyte solutions are described in commonly assigned U.S. Ser. Nos. 10/898,469, 10/990,379, 10/085,303, and 10/800,905, all hereby incorporated by reference.

Spacer 32 and spring 34 are used to provide good, uniform contact among upper cell housing 22, negative electrode 28, separator 30, positive electrode 26, and lower cell housing 24. Spacer 32 and spring 34 can be made of a conductive material that is chemically stable within cell 20, such as stainless steel.

Cell 20 can be assembled using conventional assembly methods. For example, in embodiments in which cell 50 is a thin coin cell as depicted schematically in FIG. 1, positive electrode 26 is positioned in lower cell housing 24. Separator 30 can then be positioned on top of positive electrode 26. Sufficient electrolyte solution can be added so as to saturate both positive electrode 26 and separator 30 and completely fill all available volume in lower cell housing 24. Upper cell housing 22 with annular insulating gasket 36 are positioned in bottom cell housing 24 and cell 20 hermetically sealed by mechanical crimping. Upper cell housing 22 and lower cell housing 24 can be fabricated from metal, for example, stainless steel, cold-rolled steel, nickel plated steel or aluminum.

After cell 20 is assembled, the cell is charged in situ to remove lithium from the electroactive material of positive electrode 26 and to deposit the lithium on negative electrode 28. In some embodiments, cell 20 is charged electrochemically. For example, cell 20 can be charged in a cycle including a charge to a targeted voltage of 4.4 at <1 mA/cm², then allowed to rest for one hour, followed by another charge at 4.4 V for up to 45 minutes, or until a minimum current of about 0.07 mA/cm² is achieved, followed by another rest. This charging cycle can be repeated to provide a cell fully charged at a targeted voltage. Holding the cell at very high voltage for a long time can degrade the lifetime of the cell. As used herein, a “fully charged cell” means a cell charged to remove sufficient lithium from the cathode to provide a dischargeable capacity of about 170 mah/g of cathode electroactive material. A fully charged cell can continue to show an OCV of over 4.2 V. In some embodiments, a fully charged cell has less than about 3.0 weight percent of lithium in the electroactive material of positive electrode 26 and the OCV is higher than about 4.0 V, for example, less than about 2.5 weight percent (e.g., less than about 2 weight percent) of lithium in the electroactive material of the positive electrode and an OCV of higher than 4.2 V.

Alternatively or additionally to constant current charging, cell 20 can be charged using constant voltage. For example, cell 20 can be charged by holding a cell voltage of 4.4 V after an initial charge to 4.4 V at about 1 mA/cm².

In other embodiments, cell 20 is charged ex situ. For example, prior to assembling cell 20, lithium can be removed from the electroactive material of positive electrode 26. The lithium can be removed (e.g., deintercalated) chemically, such as by treating the electroactive material with NO₂PF₆. In some embodiments, the electroactive material may be particularly air-sensitive and/or water-sensitive after the lithium is removed, so the electroactive material may need to be handled in a controlled environment (such as a drybox) to prevent degradation of the electroactive material.

During use, cell 20 is discharged in an electronic device (for example, by a consumer) without first charging the cell. Cell 20 can be discharged to a cutoff voltage, to exhaustion, or to a point where the cell is no longer wanted, and subsequently, the cell is discarded. In use, after the initial discharge of cell 20, the cell 20 is not recharged before it is discarded. Indeed, cell 20 can be configured to prevent recharging. For example, cell 20 can contain instructions that indicate that the cell is a primary or non-rechargeable cell. Alternatively or additionally, cell 20 may lack a thermistor port, which is sometimes used to protect a battery and/or an electronic device against over-current and overheating.

While a number of embodiments have been described, the invention is not so limited.

As an example, cell 20 can be a cylindrical cell (e.g., AA, AAA, 2/3A, CR2, 18650). In other embodiments, cell 20 can be non-cylindrical, such as coin cells, prismatic cells, flat thin cells, bag cells or racetrack shaped cells. Cell 20 can be a spirally wound cell.

As another example, in embodiments including LiPF₆ in the electrolyte solution, positive electrode 26 and/or cell 20 contains a low amount of water as an impurity. Without wishing to be bound by theory, it is believed that in the presence of water, LiPF₆ can be hydrolyzed forming hydrofluoric acid, which tends to corrode components of cell 20 and also can react with the anode. By reducing the amount of water, for example, in positive electrode 26, the formation of hydrofluoric acid can be reduced, thereby enhancing the performance of cell 20. In some embodiments, positive electrode 26 includes less than about 2,000 ppm of water and more than 100 ppm of water. For example, positive electrode 26 can include less than about 1,500 ppm, 1,000 ppm, or 500 ppm of water. The amount of water in positive electrode 26 can be controlled, for example, by only exposing the cathode to dry environments, such as a dry box, and/or by heating the cathode material (e.g., at about 100° C. under vacuum). In some embodiments, the water content in cell 20 can be slightly higher than the water content of positive electrode 26, such as when the electrolyte contains a small amount of water as an impurity (e.g., a maximum of about 50 ppm). As used herein, the water content of positive electrode 26 can be determined experimentally by standard Karl Fisher titrimetry. For example, water content can be determined with a Mitsubishi moisture analyzer (such as Model CA-05 or CA-06) outfitted with a sample pyrolizing unit (Model VA-05 or VA-21) using a heating temperature of 110-115° C.

The following examples are illustrative and not intended to be limiting.

### Cell Assembly and Testing

Cylindrical 18650 cells were prepared in the following manner. Positive electrode 26 consisting of 88% Li[Co_{1/3}Mn_{1/3}Ni_{1/3}]O₂, 6% conductive carbon, and 6% polyvinyldifluori (binder) was die-coated onto 25 μm aluminum foil, dried, and calendered to a final thickness of 0.008″-0.01″ final thickness. The densified positive electrode 26 was cut to lengths between 55-65 cm and ca 3 cm of coating removed using a chemical-abrasive process. An aluminum tab was ultrasonically welded to the positive electrode to provide electrical conductivity between the positive electrode and a positive terminal endcap. Negative electrode 28 consisted of 0.005″-0.007″ lithium metal, or lithium/aluminum alloy cut to lengths of 57-67 cm. A nickel-plated steel tab was pressed into the negative electrode 28 foil ca 3 cm from the edge and taped in place with a Kapton tape.

The electrodes were layered and arranged between separator 30 such that when wound onto a 4 mm diameter mandrel, the negative electrode 28 was part of an outer wrap and had a tab extending from the outer diameter of a wound jelly roll. The positive electrode 26 tab extended in the opposite direction and through the center of the jelly roll, near the void left by the mandrel. An outer wrap tape was applied to the jelly roll to prevent unraveling of the electrodes.

A non-conductive insulating annulus was inserted such that the negative electrode 28 tab was isolated from the wound stack. The jelly roll and insulator were inserted into a nickel-plated steel can where negative electrode 28 tab was resistance-welded to the can. The central positive electrode 26 tab was inserted through a second annular insulator and a bead was applied to the immobilize the jelly roll during handling. The bead is used to indicate deforming or forming a neck in the metal of the can to keep the jelly roll immobile in the bottom of the can and, at the same time, to provide a support for a crimp operation that deforms the metal above the bead compress the plastic of a main seal and thus seal the cell. The positive electrode 26 tab was resistance-welded to an end cap fitted with an insulating outer ring used for sealing the cell.

The immobilized stack was filled with electrolyte of the composition 1.0M LiPF₆, in a mixture of EC:DEC 50:50 by volume. The filled cell was crimped shut and charged as described by the 4.4 V charged protocol described previously above.

Cells were tested using the regime presented in Table 1, where steps 1 through 7 were repeated 5 times followed by a 25 minute recovery period. After the recovery period, steps 1-7 were repeated until the cell reached a target cutoff at which point, any residual capacity was measured by discharging the cell at 100Ω until the target cutoff was again reached. Cells were either discharged 8 hours after charging (“fresh’), or stored 20 days at 60C before discharging (“stored”).

TABLE 1
Simulated Digital Camera Test Profile

| Step | Power, W | Time, sec |
|---|---|---|
| 1 | 2.4 | 10 |
| 2 | 4.4 | 2 |
| 3 | 2.4 | 4 |
| 4 | 3.5 | 4 |
| 5 | 2.4 | 20 |
| 6 | 4.4 | 2 |
| 7 | 2.4 | 18 |

### EXAMPLE 1

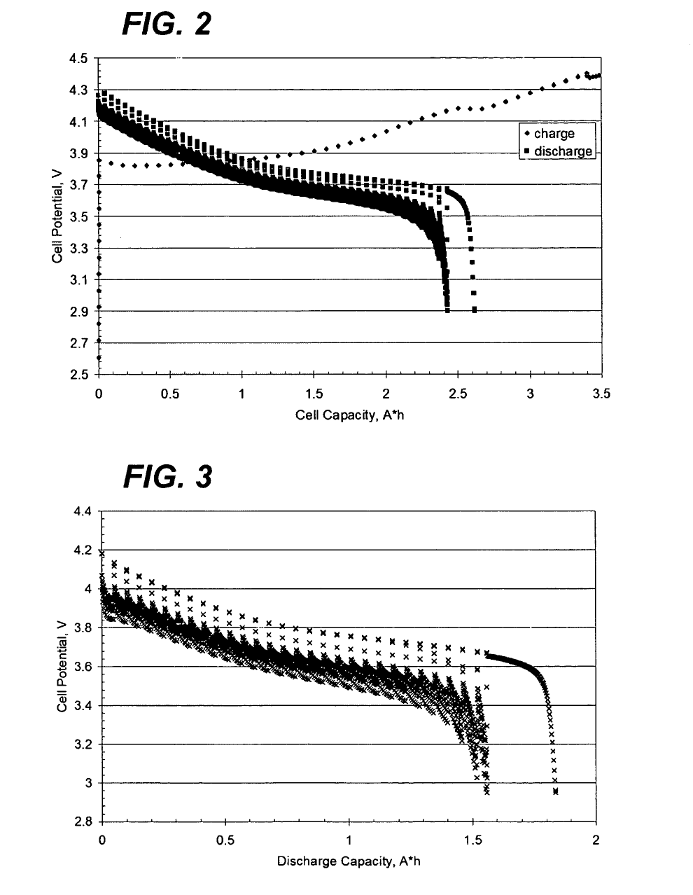

Fresh discharge performance using a negative electrode 30 having a 0.007″ lithium/aluminum alloy containing 1500 ppm Al is presented in FIG. 2 and has a performance of 460 simulated photos and a discharge capacity of 2.6 A·h.

After 20 days of storage at a temperature of 60C, some loss of capacity and performance was observed such as the average number of pulses delivered (252) and discharge capacity of (1.699 A·h). A discharge curve after storage is shown in FIG. 3.

### EXAMPLE 2

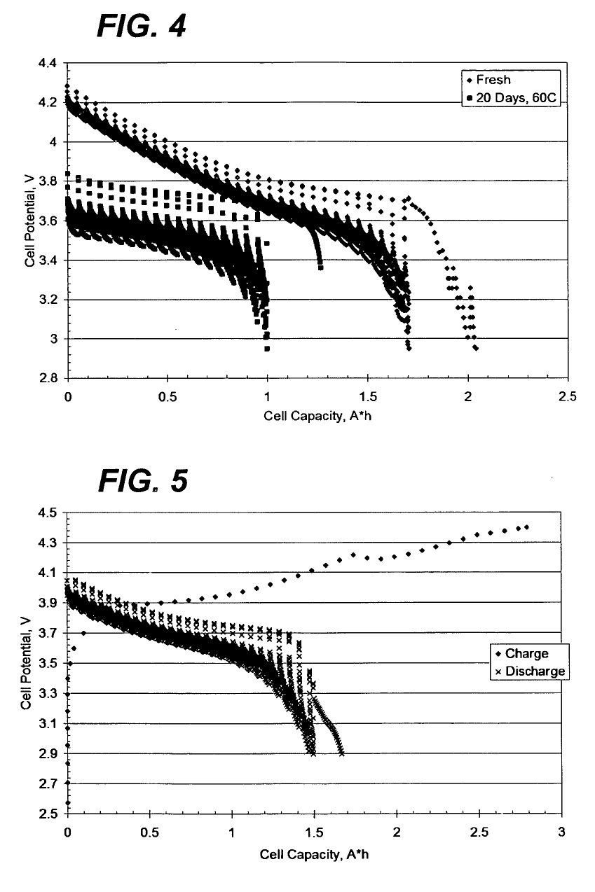

Fresh discharge performance using a negative electrode 30 having a 0.001″ copper foil is presented in FIG. 4 and has a performance of 312 simulated photos and a discharge capacity of 1.981 A·h.

After 20 days of storage at a temperature of 60C, some loss of capacity and performance was observed as can be seen by the number of pulses delivered (107) and discharge capacity of 0.920 A·h shown in FIG. 4.

### EXAMPLE 3

Fresh discharge performance using a negative electrode 30 having a 0.004″ hot-tin-dipped copper foil is presented in FIG. 5 and has a performance of 312 simulated photos and a discharge capacity of 1.981 A·h.

### EXAMPLE 4

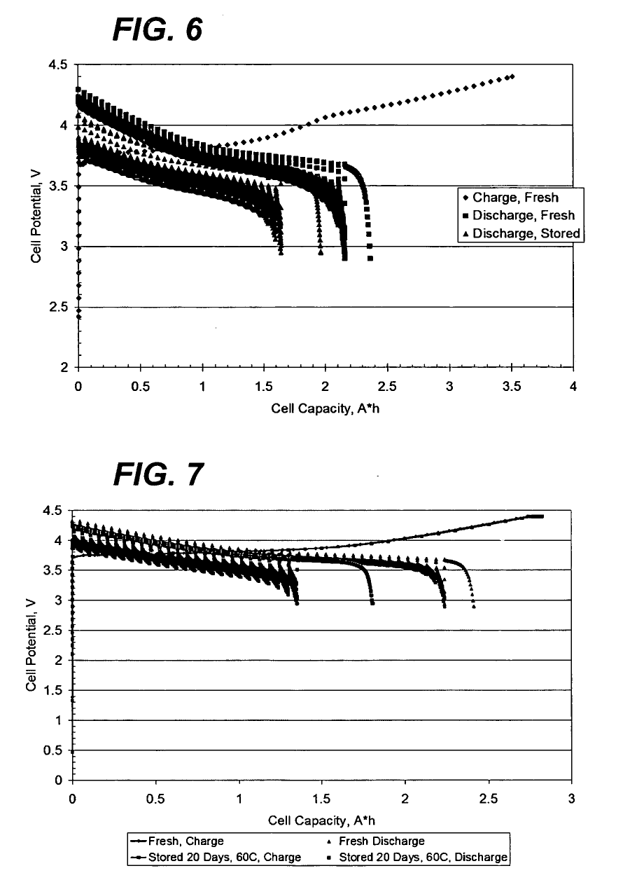

Fresh discharge performance using a negative electrode 30 having a 0.0007″ copper foil, vapor deposited with 10 μm of Li per side, is presented in FIG. 6 and has an average performance of 423 simulated photos and a discharge capacity of 2.418 A·h. After 20 days of storage, the performance was measured to be an average of 217 photos with an average discharge capacity of 1.547 A·h.

### EXAMPLE 5

Fresh discharge performance using a negative electrode 30 having a 0.0007″ copper foil electrochemically deposited with ca. 3.8 μm of zinc per side, is presented in FIG. 7 and has an average performance of 398 simulated photos and a discharge capacity of 2.235 A·h. After 20 days of storage, the performance was measured to be an average of 224 photos with an average discharge capacity of 1.731 A·h.

A tabulated comparison of all examples is presented in Table 2.

TABLE 2
Performance Comparison

| | Fresh Performance | | | 20 Day, 60 C. Stored Performance | | |
|---|---|---|---|---|---|---|
| | Average Charge | Average | Average Discharge | Average Charge | Average | Average Discharge |
| Example | Capacity, A * h | Pulse Count | Capacity, A * h | Capacity, A * h | Pulse Count | Capacity, A * h |
| 1 | 3.806 | 364 | 2.094 | 3.026 | 252 | 1.699 |
| 2 | 3.582 | 312 | 1.981 | 3.348 | 107 | 0.920 |
| 3 | 3.291 | 255 | 1.593 | — | — | — |
| 4 | 3.285 | 423 | 2.418 | 3.891 | 217 | 1.547 |
| 5 | 2.801 | 398 | 2.235 | 2.771 | 224 | 1.731 |

All references, such as published and non-published patent applications, patents, and other publications, referred to herein are incorporated by reference in their entirety.

Other embodiments are within the claims.

What is claimed is:

1. A primary battery, comprising:
a positive electrode comprising a first material capable of bonding with lithium;
a negative electrode comprising lithium; and
a non-aqueous electrolyte,
wherein the battery is capable of providing an average load voltage of greater than about 3.5 volts.

2. The battery of claim 1, wherein the first material comprises a mixed metal oxide.

3. The battery of claim 1, wherein the first material is selected from the group consisting of Li(Ni,Co,Mn)O₂ and Li(Mn,Ni)O₂.

4. The battery of claim 1, wherein the first material has less than about three percent by weight of lithium prior to an initial discharge of the battery.

5. The battery of claim 1, wherein the positive electrode is in a fully charged state prior to an initial discharge of the battery.

6. The battery of claim 1, wherein the negative electrode comprises a solid solution comprising lithium.

7. The battery of claim 1, wherein the negative electrode comprises an alloy comprising lithium.

8. The battery of claim 1, wherein the negative electrode comprises a substrate and a first layer on the substrate, the first layer capable of combining with lithium.

9. The battery of claim 8, wherein the substrate comprises copper, and the first layer comprises an alloy comprising copper.

10. The battery of claim 9, wherein the alloy further comprises tin.

11. A method of making a primary battery, the method comprising:
assembling a positive electrode comprising a first material capable of bonding with lithium, a negative electrode, and a non-aqueous electrolyte into a battery housing; and
fully charging the battery, wherein the battery is capable of providing an average load voltage of greater than about 3.5 volts.

12. The method of claim 11, wherein the first material comprises a mixed metal oxide.

13. The method of claim 11, wherein the first material is selected from the group consisting of Li(Ni,Co,Mn)O₂ and Li(Mn,Ni)O₂.

14. The method of claim 11, wherein the first material has less than about three percent by weight of lithium after the battery is fully charged.

15. The method of claim 11, wherein charging the battery comprises forming a solid solution comprising lithium in the battery housing.

16. The method of claim 11, wherein charging the battery comprises forming an alloy comprising lithium in the battery housing.

17. The method of claim 11, wherein the negative electrode comprises an alloy.

18. The method of claim 17, wherein the alloy comprises at least one element selected from the group consisting of copper and tin.

19. The method of claim 11, wherein the negative electrode comprises a substrate, and a first layer on the substrate, the first layer having a different composition than a composition of the substrate.

20. The method of claim 11, wherein the negative electrode is substantially free of lithium prior to an initial charging.

21. The method of claim 20, wherein charging the battery increases a lithium content of the negative electrode.

22. The method of claim 11, wherein the negative electrode comprises lithium prior to an initial charging.

23. A method, comprising:
discharging, without previously charging, a battery comprising
a positive electrode comprising a first material capable of bonding with lithium,
a negative electrode comprising lithium, and
a non-aqueous electrolyte, the battery capable of providing an average load voltage of greater than about 3.5 volts; and
after discharging the battery, discarding the battery the battery without charging the battery.

24. The method of claim 23, wherein the first material comprises a mixed metal oxide.

25. The method of claim 23, wherein the first material is selected from the group consisting of Li(Ni,Co,Mn)O₂ and Li(Mn,Ni)O₂.

26. The method of claim 23, wherein the first material has less than about three percent by weight of lithium prior to discharging the battery.

27. The method of claim 23, wherein the positive electrode is in a fully charged state prior to discharging the battery.

28. The method of claim 23, wherein the negative electrode comprises a solid solution comprising lithium.

29. The method of claim 23, wherein the negative electrode comprises an alloy comprising lithium.

30. The method of claim 23, wherein the negative electrode comprises a substrate and a first layer on the substrate, the first layer capable of combining with lithium.

31. The method of claim 30, wherein the substrate comprises copper, and the first layer comprises an alloy comprising copper.

32. The method of claim 31, wherein the alloy further comprises tin.
